(19) United States
(12) Patent Application Publication
(10) Pub. No.: US 2026/0366642 A1
(43) Pub. Date: Nov. 19, 2026

(54) MAGNETICALLY COUPLED VALVE

(71) Applicant: Elemental Scientific, Inc., Omaha, NE (US)

(72) Inventors: Austin Schultz, Omaha, NE (US); Caleb Gilmore, Omaha, NE (US); Tyler Yost, Omaha, NE (US)

(21) Appl. No.: 19/751,853

(22) Filed: Jul. 23, 2026

Related U.S. Application Data
(63) Continuation-in-part of application No. 18/903,396, filed on Oct. 1, 2024, now Pat. No. 12,692,955.
Application No. 18/903,396 is a continuation of application No. 17/949,538, filed on Sep. 21, 2022, now Pat. No. 12,104,710.
(60) Provisional application No. 63/248,098, filed on Sep. 24, 2021.

(51) Int. Cl. F16K 31/04

(52) U.S. Cl. CPC F16K 31/041; F16K 31/043

(57) ABSTRACT

Valve assemblies are described providing magnetic coupling between a valve actuator and a valve body. The valve body includes a rotor and a stator configured to define a plurality of fluid flow passageways. The valve actuator is configured to drive the rotor via a drive shaft. A mount assembly magnetically couples the valve body and the valve actuator.

### BACKGROUND

Inductively Coupled Plasma (ICP) spectrometry is an analysis technique commonly used for the determination of trace element concentrations and isotope ratios in liquid samples. ICP spectrometry employs an electromagnetically generated partially ionized argon plasma that reaches a temperature of approximately 7,000 K. When a sample is introduced into the plasma, the high temperature causes sample atoms to become ionized or emit light. Since each chemical element produces a characteristic mass or emission spectrum, measuring the spectra of the emitted mass or light allows the determination of the elemental composition of the original sample.

Sample introduction systems may be employed to introduce the liquid samples into the ICP spectrometry instrumentation, such as an Inductively Coupled Plasma Mass Spectrometer (ICP-MS), an Inductively Coupled Plasma Atomic Emission Spectrometer (ICP-AES), or the like) for analysis. For example, a sample introduction system may withdraw an aliquot of a liquid sample from a container and thereafter transport the aliquot, via one or more fluid pathways controlled by valve configurations, to a nebulizer that converts the aliquot into a polydisperse aerosol suitable for ionization in plasma by the ICP spectrometry instrumentation. The aerosol is then sorted in a spray chamber to remove the larger aerosol particles. Upon leaving the spray chamber, the aerosol is introduced into the plasma by a plasma torch assembly of the ICP-MS or ICP-AES instrument for analysis.

### SUMMARY

Valve assemblies are described that provide magnetic coupling between a valve actuator and a valve body housing a valve rotor and stator. In embodiments, the valve assembly includes a valve body that includes a rotor and a stator configured to define a plurality of fluid flow passageways, a valve actuator configured to drive the rotor via a drive shaft, and a mount assembly. The mount assembly is configured to detachably magnetically couple the valve body and the valve actuator.

In embodiments, the valve assembly includes a valve body configured to detachably couple to a valve actuator via magnetic coupling. The valve body includes a rotor and a stator configured to define a plurality of fluid flow passageways through the valve assembly. A drive shaft extends through a shaft aperture formed in the valve body; the drive shaft being configured to couple between the rotor and the valve actuator to drive the rotor. The mount assembly comprises at least one magnet housed within an interior region defined by the valve body. The at least one magnet is configured to magnetically couple to the valve actuator. In an embodiment, the valve assembly further includes at least one of a protrusion configured to insert into an aperture on the valve actuator or an aperture configured to receive a protrusion on the valve actuator to prevent rotation of the valve body relative to the valve actuator when magnetically coupled.

In other embodiments, the valve assembly includes a valve body including a rotor and a stator configured to define a plurality of fluid flow passageways, and a valve actuator configured to drive the rotor via a drive shaft. A mount assembly magnetically couples the valve body and the valve actuator. The mount assembly includes a collar coupled to the valve actuator and a ring coupled to the valve body. The collar and/or ring comprise at least one magnet and/or ferromagnetic material configured to detachably couple the ring to the collar to magnetically couple the valve body to the valve actuator. For example, in one embodiment, the collar includes one or more magnets, while the ring comprises ferromagnetic material that is magnetically attracted to the magnets in the collar to secure the ring to the collar. In another embodiment, the ring includes one or more magnets, while the collar comprises ferromagnetic material that is magnetically attracted to the magnets in the ring to secure the ring to the collar. In a further embodiment, both the collar and ring include one or more magnets, whose poles are aligned (e.g., North (N) to South (S)) to attract one another to secure the ring to the collar.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is an isometric view of a valve assembly having magnetic coupling between a valve actuator and a valve body in accordance with embodiments of the present disclosure.

FIG. 2 is a partial exploded view of the valve assembly of FIG. 1 showing a rear side of the valve body having slotted apertures to receive stability protrusions from an actuator mount on the valve actuator in accordance with embodiments of the present disclosure.

FIG. 3 is a partial exploded view of a valve body having an annular region to house a magnet and having a valve body cover to seal the magnet within the valve body for magnetically coupling the valve body to a valve actuator in accordance with embodiments of the present disclosure.

FIG. 4 is a cross-sectional view of the valve body of FIG. 3 having the magnet within the valve body to couple to an actuator mount and having a drive shaft within the valve body to turn a valve rotor under control by a valve actuator in accordance with embodiments of the present disclosure.

FIG. 5 is a side view of a valve body having a tapered body structure in accordance with embodiments of the present disclosure.

FIG. 6A is a top plan view of the rear of a valve body having slotted apertures positioned adjacent a valve body skirt to receive stability protrusions from an actuator mount in accordance with embodiments of the present disclosure.

FIG. 6B is an isometric view of the valve body of FIG. 6A.

FIG. 7A is a top plan view of the rear of a valve body having slotted apertures positioned radially inward from a cavity configured to hold one or more magnets, the slotted apertures positioned to receive stability protrusions from an actuator mount in accordance with embodiments of the present disclosure.

FIG. 7B is an isometric view of the valve body of FIG. 7A.

FIG. 7C is an isometric view of an actuator mount having stability protrusions to interface with the slotted apertures of the valve body of FIG. 7A.

FIG. 8A is a top plan view of the rear of a valve body having slotted apertures positioned on an outer edge of the valve body, the slotted apertures positioned to receive stability protrusions from an actuator mount in accordance with embodiments of the present disclosure.

FIG. 8B is an isometric view of the valve body of FIG. 8A.

FIG. 8C is an isometric view of an actuator mount having stability protrusions to interface with the slotted apertures of the valve body of FIG. 8A.

FIG. 9A is a front view of a valve assembly having a housing to support one or more fluid sensors and having magnetic coupling between a valve actuator and a valve body in accordance with embodiments of the present disclosure.

FIG. 9B is an exploded view of a rear of the valve assembly of FIG. 9A with the valve body having an annular region to house a magnet and having a valve body cover to seal the magnet within the valve body for magnetically coupling the valve body to a valve actuator mount having stability protrusions to interface with the slotted apertures of the valve body in accordance with embodiments of the present disclosure.

FIG. 10 is an isometric view illustrating a valve assembly employing a mount assembly furnishing magnetic coupling between a valve actuator and a valve body in accordance with additional embodiments of the present disclosure.

FIG. 11 is an exploded isometric view of the valve assembly shown in FIG. 10.

FIG. 12 is an isometric view illustrating a valve assembly employing a mount assembly furnishing magnetic coupling between a valve actuator and a valve body, wherein the valve body is replaced with a second valve body, in accordance with additional embodiments of the present disclosure.

FIG. 13 is an exploded isometric view of the valve assembly shown in FIG. 12.

FIG. 14 is an exploded isometric view of the magnetic mount assembly employed by the valve assembly shown in FIGS. 10-13, in accordance with an example embodiment of the present disclosure.

FIG. 15 is an exploded isometric view further illustrating the collar of the magnetic mount assembly shown in FIG. 14.

FIG. 16 is a side elevational cross section view of the collar shown in FIG. 15.

FIG. 17 is an isometric view further illustrating the ring of the magnetic mount assembly shown in FIG. 16.

FIG. 18 is a side elevational cross section view of the ring shown in FIG. 17.

### DETAILED DESCRIPTION

Multiport valves are used to transport and prepare fluid samples for analysis by laboratory equipment. For example, multiport valves can be used to introduce liquid samples into ICP spectrometry instrumentation for analysis through fluid connections via tubing coupled with ports of the valves. Multiport valves can also be used to load samples on columns for liquid and/or gas chromatography. Valves used in these applications can include six-port (6-port), two-position (2-position) rotary valves, although valves having fewer or greater numbers of ports and/or having more than two positions also can be used. Generally, two ports of a rotary valve are connected to an external (sample) loop or fluid holding line, one port is connected to a sample source, another port is connected to a carrier source, a further port is connected to a vent (waste), and another port is connected to a nebulizer/column. When the valve is in a first orientation, sample from the sample source flows into and through a sample loop, while carrier from the carrier source flows directly to a nebulizer/column. When the valve is rotated to a second orientation, the carrier source is connected to the sample loop for injecting the sample contained in the sample loop into the nebulizer or onto the column. In some multiport configurations, one fluid is mixed with another fluid by injecting the two fluids into separate ports or channels of a multiport valve. In these configurations, the two fluids meet to introduce the fluid flowing from one flow path to fluid flowing from another flow path to mix the fluid streams.

To facilitate the switching of valve orientations, valve assemblies can include a valve actuator having a motor or drive to rotate a valve rotor relative to a valve stator within the valve body. The rotor includes channels that selectably couple ports formed by the stator, where rotation of the rotor causes the channels to move between ports depending on operation of the valve actuator. Since each of the valve actuator and the valve body house moving parts, such as the motor and the rotor, valve assemblies can include valve collars that hold the valve body stationary relative to the actuator. For example, the valve collar can include fasteners or fittings, such as bolts, that physically bias the collar against structures present on the valve body and the actuator (e.g., via friction fit), which can prevent rotation of the valve body with respect to the actuator when the actuator rotates the rotor within the valve body.

Such valve configurations reliant on the valve collar can present drawbacks for many laboratory operations. For example, the fasteners or fittings on the valve collar can become loosened during use of the valve, which can reduce the force the collar applies against the valve body and the actuator. As the valve collar loosens, portions of the valve body can rotate and cause the valve to no longer be calibrated or otherwise create a risk of faulty valve operation or positioning. Further, the fasteners or fittings can loosen based on environmental or valve system temperature fluctuations, such as by loosening in response to frequent changes between hot and cold temperatures in the laboratory environment or based on the temperature of fluids flowing through the valve. As another example, the valve collars can require additional tools and hardware for installation, which can complicate the installation process or introduce risks of improper alignment of the valve body during installation.

Accordingly, the present disclosure is directed to valve assemblies that provide magnetic coupling between a valve actuator and a valve body housing a valve rotor and stator. In embodiments, the valve assembly comprises a valve body that includes a rotor and a stator configured to define a plurality of fluid flow passageways, a valve actuator configured to drive the rotor via a drive shaft, and a mount assembly. The mount assembly is configured to detachably magnetically couple the valve body and the valve actuator.

In embodiments, the mount assembly comprises one or more magnets within the valve body to magnetically couple to an actuator mount secured to the valve actuator without use of a separate valve collar. The valve body and the actuator mount include one or more mating features to prevent rotation of the valve body relative to the valve actuator. In an aspect, the valve body includes one or more slotted apertures to receive stability protrusions from the actuator mount secured to the valve actuator to provide resistance to rotational movement of the valve body relative to the valve actuator. In an aspect, the one or more magnets within the valve body are displaced radially outward from an axis of rotation of a drive shaft coupled between the valve rotor and a motor of the valve actuator. The one or more magnets provide a magnetic coupling through the valve body to the actuator via the actuator mount. In an embodiment, the magnetic coupling between the valve body and the valve actuator provides sufficient force to stably couple the valve body and the valve actuator without use of a valve collar, providing a more compact size for the valve assembly without risk of a loosened coupling between the valve body and the valve actuator (e.g., due to loosened fasteners, temperature fluctuations, etc.). Moreover, the valve body can be removed without hardware or tools to loosen valve collar couplings, providing convenient methods to replumb fluid lines introduced to the stator or swap in a different valve body (e.g., having different fluid connections, different fluid flow requirements, etc.).

In other embodiments, the mount assembly includes a collar coupled to the valve actuator and a ring coupled to the valve body. The collar and ring detachably magnetically couple the valve body to the valve actuator so that the valve body can be removed from the valve actuator, thereby allowing the valve body to be removed and replaced as desired. In embodiments, the collar and/or ring comprise at least one magnet (and/or ferromagnetic material) configured to detachably couple the ring to the collar to magnetically couple the valve body to the valve actuator. For example, in one embodiment, the collar includes one or more magnets, while the ring comprises ferromagnetic material, which is magnetically attracted to the magnets in the collar to secure the ring to the collar. In another embodiment, the ring includes one or more magnets, while collar comprises ferromagnetic material, which is magnetically attracted to the magnets in the ring to secure the ring to the collar. In a further embodiment, both the collar and ring include one or more magnets having poles aligned to attract one another.

### Example Embodiments

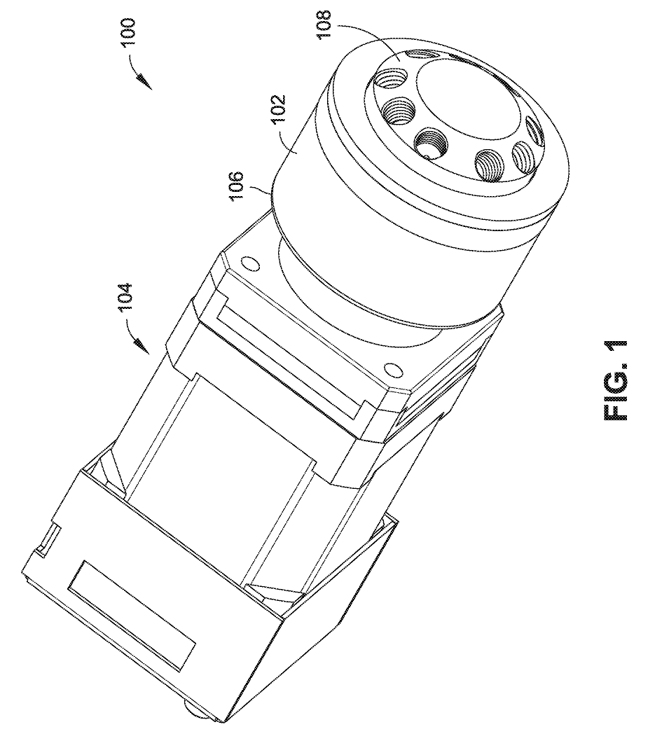

FIGS. 1-9B illustrate a valve assembly providing magnetic coupling between a valve body and portions of a valve actuator configured to drive operation of the valve body (“valve 100”). The valve 100 generally includes a valve body 102, a valve actuator 104, and an actuator mount 106 coupled between the valve body 102 and the valve actuator 104. The valve body 102 houses a rotor and a stator to form fluid flow pathways through which fluids can pass into the valve via one or more ports and are directed out from the valve through other ports based on the valve configuration formed by channels in the rotor and ports of the stator. The fluid flow pathways are configured to pass fluids that include, but are not limited to, liquids, gases, vapors, fluids containing dissolved solids, fluids carrying entrained liquids, solids, or gases, and combinations thereof. For example, FIG. 1 shows nine ports on a valve face 108 to couple with nine fluid lines, however the valve assembly 100 is not limited to nine ports and can include greater than nine ports or fewer than nine ports. Moreover, the valve assembly 100 is not limited to ports having removably coupled fluid lines and can include fluid lines permanently coupled to one or more stator ports. The valve actuator 104 generally includes a motor or drive to rotate the valve rotor relative to the valve stator within the valve body 102 when the valve body 102 is coupled to the valve actuator 104 via magnetic coupling between the valve body 102 and the actuator mount 106, described further herein. The rotor includes channels that selectably couple ports formed by the stator, where rotation of the rotor causes the channels to move between ports depending on operation of the valve actuator 104. In embodiments, the valve body 102 has a generally cylindrical shape (e.g., as shown in FIGS. 1-3), however the valve body 102 is not limited to such shapes and can include, for example, a tapered shape (e.g., as shown in FIG. 5), a rectangular shape, an irregular shape, or another shape.

The valve body 102 detachably couples to the valve actuator 104 via magnetic interactions between the valve body 102 and the actuator mount 106 that is secured to the valve actuator 104. For example, a user of the valve assembly 100 can grasp the valve body 102 and pull away from the valve actuator 104 to overcome the force of the magnetic coupling to remove the valve body 102 and subsequently reintroduce the same or different valve body 102 to the valve actuator 104 by placing the valve body 102 in proximity to the actuator mount 106.

In embodiments, the actuator mount 106 defines an aperture 200 through which a drive shaft 202 rotatably coupled to the valve body 102 (e.g., via one or more internal bearings) passes to couple with a motor or drive of the valve actuator 104. The actuator mount 106 is fixedly coupled to an end 204 of the valve actuator 104 to receive the drive shaft of the valve body 102 through the aperture 200. For example, the actuator mount 106 is shown with a plurality of fastener apertures 206 to receive fasteners for securing the actuator mount 106 to the end 204 of the valve actuator 104. In embodiments, the actuator mount 106 is constructed from a magnetically attractive material such that the actuator mount 106 is attracted by a magnet or includes a magnetic material attracted to one or more magnets of the valve body 102.

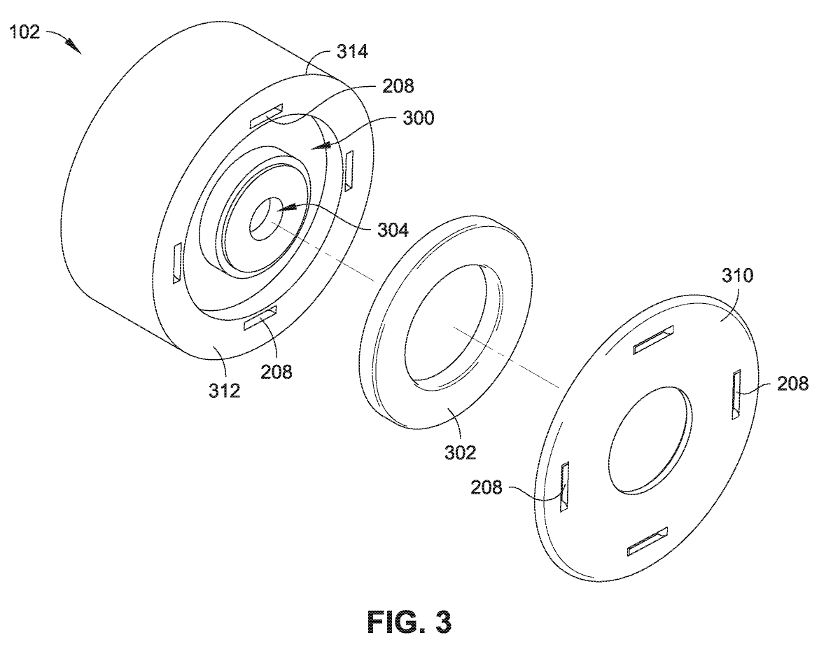

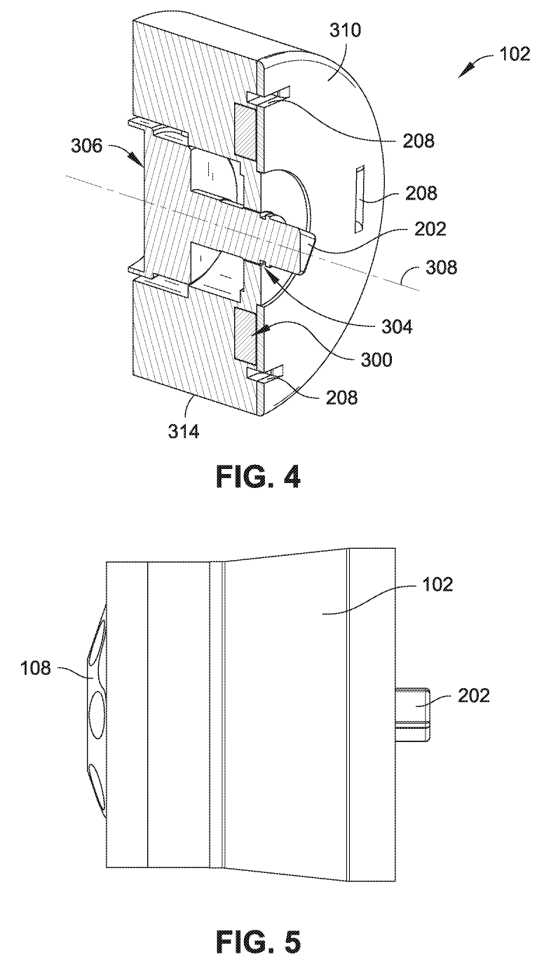

The valve body 102 can support one or more magnets in an interior of the valve body 102, on an exterior of the valve body 102, or combinations thereof, to provide magnetic coupling with the actuator mount 106. For example, referring to FIGS. 3 and 4, the valve body 102 is shown having an annular region 300 to house a ring-shaped magnet 302 within an interior of the valve body 102. The ring-shaped magnet 302 surrounds a shaft aperture 304 formed by the valve body 102 through which the drive shaft 202 can pass to couple between a valve rotor 306 and the valve actuator 104. For example, the magnet 302 (or a plurality of magnets 302) can be positioned radially outward from an axis of rotation 308 of the drive shaft 202. The valve body 102 is also shown with a valve body cover 310 configured to couple to an end 312 of the valve body 102 that is configured to face the actuator mount 106 to couple the magnet 302 within the valve body 102.

In embodiments, the valve body cover 310 is ultrasonically welded in place on the valve body 102 to seal the magnet 302 within the annular region 300 of the valve body 102. Interior positioning of the magnet 302 can separate the magnet 302 from an external environment of the valve assembly 100, which can prevent exposure of metallic components of the magnet 302 to nearby sample containers (e.g., sample vials awaiting testing), which can prevent interaction between fragments of the magnet 302 and the samples held in the sample containers to avoid potential contamination risks (e.g., when the valve assembly 100 is used in corrosive sample environments). While the magnet 302 is shown having a ring-shaped configuration, the valve assembly 100 is not limited to such magnet configurations and can include other magnet configurations including, but not limited to, one or more rectangular magnets, one or more square magnets, one or more irregularly shaped magnets, a pattern of individual magnets, a singular magnet, or the like, or combinations thereof.

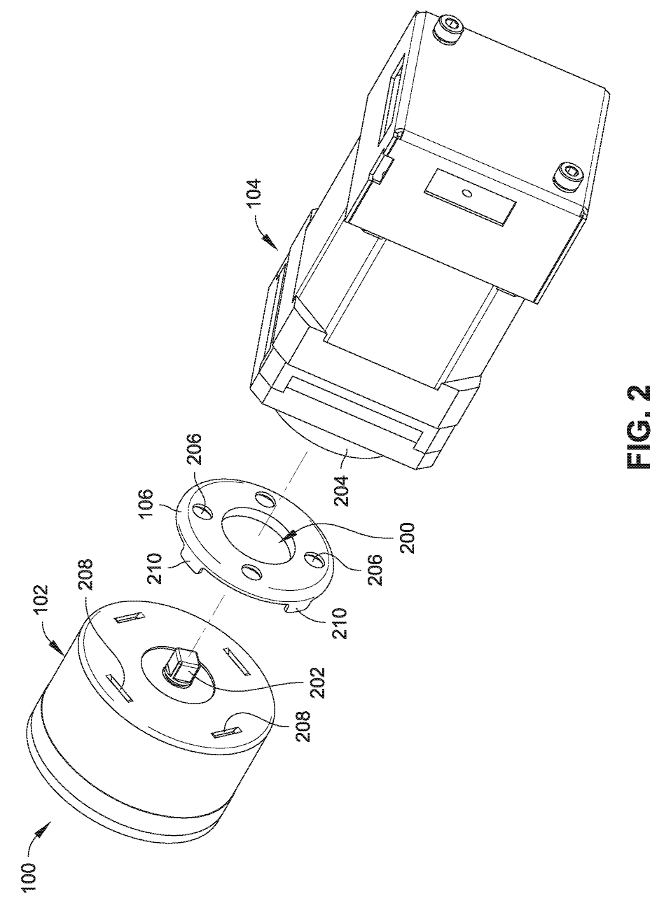

In embodiments, the valve body 102 and the actuator mount 106 include one or more mating features to prevent rotation of the valve body 102 relative to the valve actuator 104. For example, referring to FIGS. 2 and 3, the valve body 102 is shown with slotted apertures 208 positioned to receive stability protrusions 210 extending from the actuator mount 106. The stability protrusions are introduced into the slotted apertures 208 during magnetic coupling of the valve body 102 to the actuator mount 106 and provide resistance to rotational movement of the valve body 102 relative to the valve actuator 104 due to interaction between the stability protrusions 210 and the valve body 102 when inserted into the slotted apertures 208. The slotted apertures 208 can be provided through each of the valve body cover 310 and the end 312 of the valve body 102 (e.g., as shown in FIG. 3), can be provided through just the valve body cover 310, or can have a combination of one or more apertures through each of the valve body cover 310 and the end 312 of the valve body 102 and one or more apertures through just the valve body cover 310.

While the valve assembly 100 is shown with a plurality of slotted apertures 208 and a plurality of corresponding stability protrusions 210, the valve assembly 100 is not limited to a particular number or arrangement of mating features. For example, the valve assembly 100 can include a single aperture 208 and a single corresponding stability protrusion 210, the valve assembly 100 can include fewer than four apertures 208 and corresponding stability protrusions 210, the valve assembly 100 can include greater than four apertures 208 and corresponding stability protrusions 210, or the like. Additionally, the valve assembly 100 is not limited to the slotted shapes of the apertures 208 and the protrusions 210 and can include any shape of aperture 208 and corresponding shape of protrusion 210. In embodiments, the positioning of the aperture(s) 208 and the protrusion(s) 210 provide a keyed arrangement of the valve body 102 relative to the valve actuator 104, such that the valve body 102 is oriented in a particular direction relative to the valve actuator 104, which can ensure proper orientation of the valve assembly 100 for fluid flow configurations and changing valve orientations via rotation of the rotor 306 by the valve actuator 104. Alternatively or additionally, the magnets 302 and the actuator mount 106 can provide a keyed arrangement of the valve body 102 relative to the valve actuator 104, such as by providing selective areas of the actuator mount 106 with magnetically attractive material, and with the remaining areas of the actuator mount 106 being not magnetically attractive, by providing magnets with opposing poles on each of the valve body 102 and the actuator mount 106 to magnetically couple in a particular orientation, or the like.

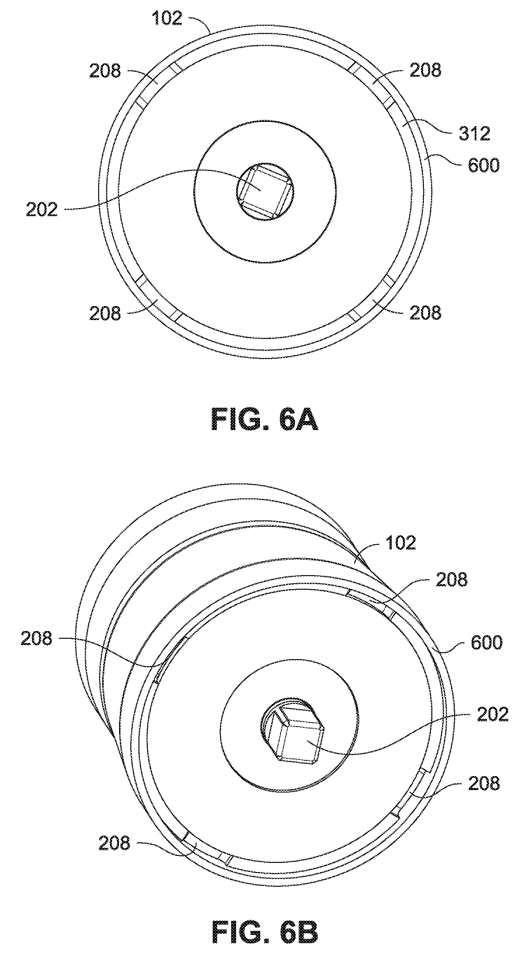

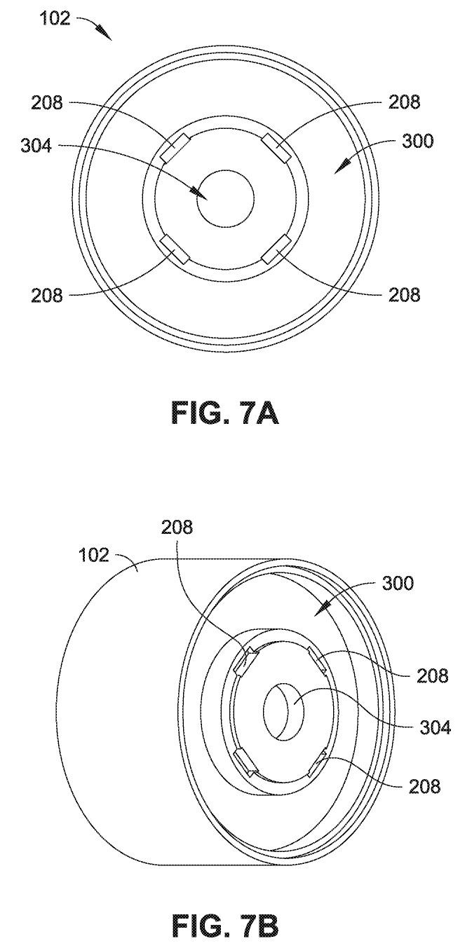

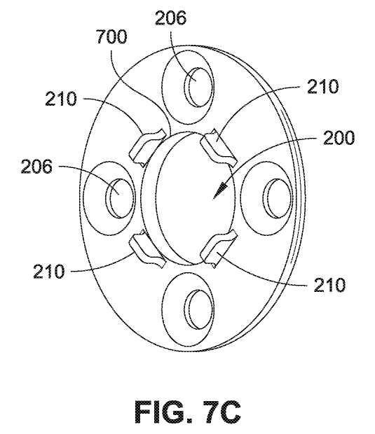

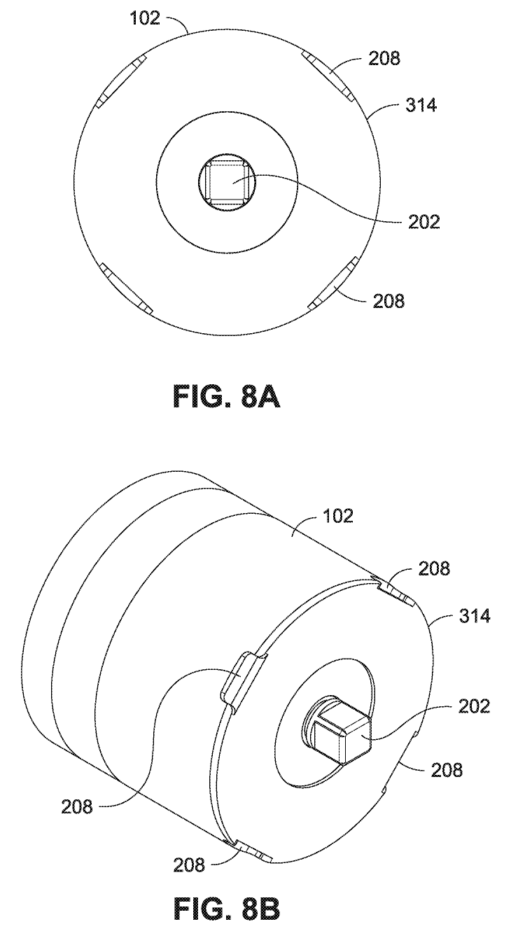

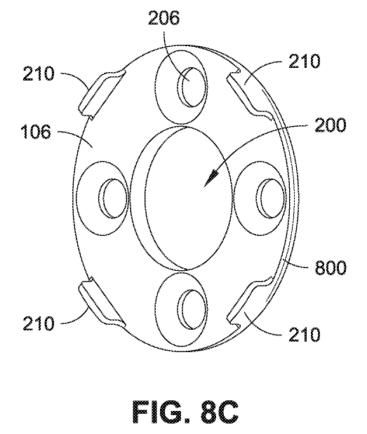

The positioning of the apertures 208 on the valve body 102 and the protrusions 210 on the actuator mount 106 can be varied to provide multiple coupling arrangements and to accommodate different sizes of the valve body 102 and the actuator mount 106 (e.g., such as when the actuator mount 106 can interface with multiple different types or sizes of valve body 102). For example, the apertures 208 can be positioned radially outward from the annular region 300 and radially inward from an exterior edge 314 of the valve body 102, as shown in FIGS. 3 and 4, with the actuator mount 106 having corresponding positions for the protrusions 210. Alternatively or additionally, the apertures 208 can be positioned radially inward from the annular region 300 of the valve body 102, as shown in FIGS. 7A and 7B, with the actuator mount 106 having corresponding positions for the protrusions 210 (e.g., adjacent an interior edge 700 that forms the aperture 200, as shown in FIG. 7C). Alternatively, or additionally, the apertures 208 can be positioned radially outward from the annular region 300 at the exterior edge 314 of the valve body 102, as shown in FIGS. 8A and 8B, with the actuator mount 106 having corresponding positions for the protrusions 210 (e.g., on an exterior edge 800 of the actuator mount 106, as shown in FIG. 8C). In embodiments, the valve body 102 includes a skirt 600 extending from the end 312 in a direction towards the actuator mount 106 with the apertures 208 positioned radially inward from the skirt 600 (e.g., as shown in FIGS. 6A and 6B).

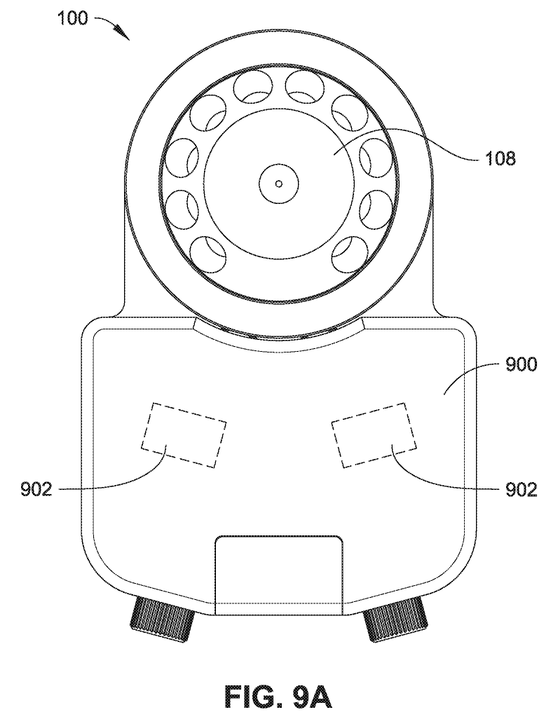

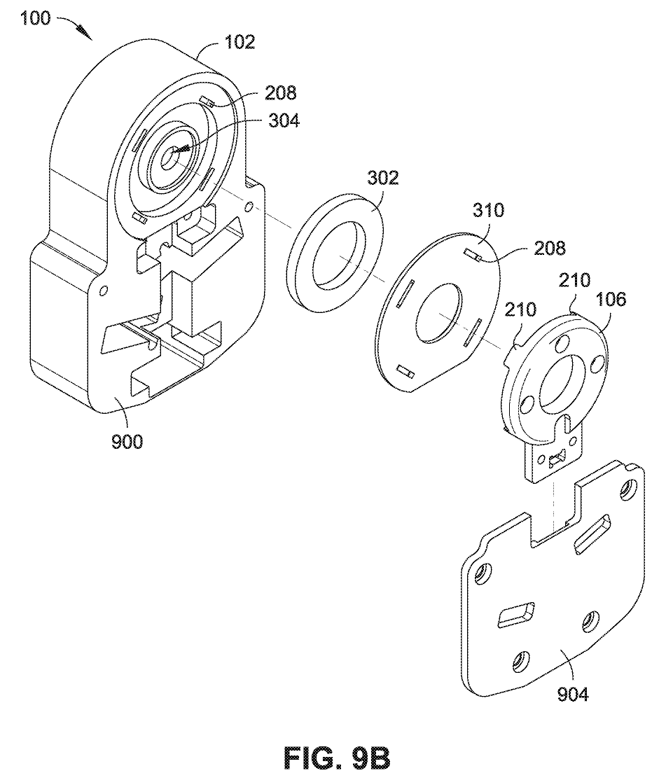

In embodiments, the valve assembly 100 can include one or more fluid sensors to magnetically couple the valve with the fluid sensors to the valve actuator 104. For example, referring to FIGS. 9A and 9B, the valve assembly 100 is shown with a sensor housing 900 configured to house one or more sensors 902 within the sensor housing 900. The valve assembly 100 can include a housing cover 904 to seal the sensors 902 within the sensor housing 900. In embodiments, the housing cover 904 is positioned adjacent to the actuator mount 106 when the valve body 102 is magnetically coupled with the valve actuator 104 via the actuator mount 106.

It should be noted that while the terms “stator” and “rotor” are used herein to describe the portions of the valve assembly 100 defining fluid flow pathways, these terms are provided by way of example only (e.g., to illustrate how these components interface (e.g., rotate) with respect to one another), and are not meant to limit how the valve members can be actuated with respect to an external reference (e.g., valve mounting hardware, or the like). Thus, in one particular example, a component described as a “stator” may remain substantially stationary (e.g., with respect to an external reference, such as valve mounting hardware), and a component described as a “rotor” may rotate with respect to the stator. However, in another particular example, a component described as a “stator” may rotate with respect to a rotor, and a component described as a “rotor” may remain substantially stationary (e.g., with respect to valve mounting hardware). Further, in some embodiments, both a component described as a “stator” and a component described as a “rotor” may rotate with respect to an external reference.

Further, while the valve assembly 100 is described with the valve body 102 having one or more apertures 208 and the actuator mount 106 having one or more corresponding protrusions 210, it is noted that the apertures 208 can be positioned on either or both of the valve body 102 and the actuator mount 106, with the corresponding protrusions 210 positioned on the other of the valve body 102 and the actuator mount. For example, in some embodiments, one or more apertures 208 can be formed by the actuator mount 106 with one or more protrusions 210 extending from the valve body 102.

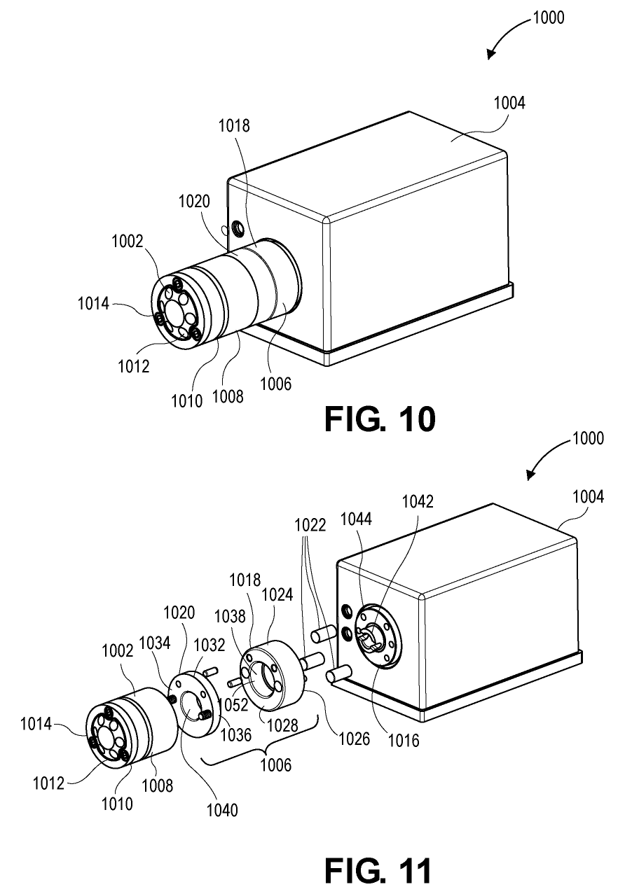

FIGS. 10 -17 illustrate another embodiment of a valve assembly 1000 in accordance with the present disclosure providing magnetic coupling between a valve body 1002 and a valve actuator 1004 configured to drive operation of the valve body 1002. As shown, the valve assembly 1000 generally includes the valve body 1002, the valve actuator 1004, and a mount assembly 1006 configured to couple the valve body 1002 to the valve actuator 1004. The valve body 1002 houses a rotor 1008 and a stator 1010 to form fluid flow pathways through which fluids can pass into the valve via one or more ports 1012 and are directed out from the valve body 1002 through other ports 1012 based on the valve configuration formed by channels in the rotor 1008 and ports of the stator 1010. The fluid flow pathways are configured to pass fluids that include, but are not limited to, liquids, gases, vapors, fluids containing dissolved solids, fluids carrying entrained liquids, solids, or gases, and combinations thereof. For example, FIG. 10 shows valve body 1002 having multiple ports 1012 on a valve face 1014 to couple with a corresponding number of fluid lines. In the embodiment illustrated in FIGS. 10 and 11, a valve body having eight (8) ports 1012 is shown, however the valve body 1002 is not limited to eight (8) ports 1012 and can include greater than eight (8) ports 1012 or fewer than eight (8) ports 1012 on the valve face 1014.

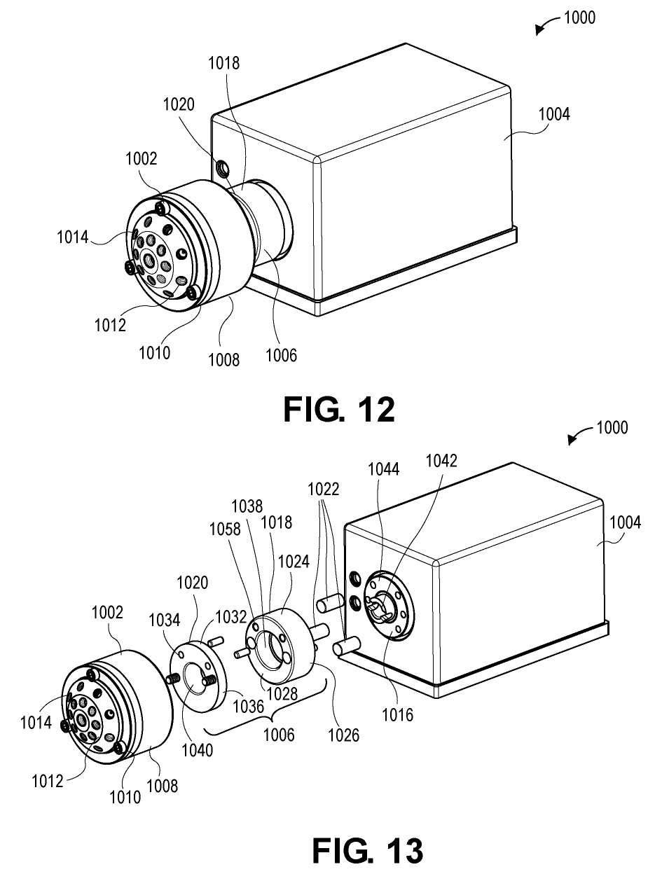

The valve actuator 1004 generally includes a motor or drive 1016 to rotate the valve rotor 1008 relative to the valve stator 1010 within the valve body 1002 when the valve body 1002 is coupled to the valve actuator 1004 via magnetic coupling between the valve body 1002 and the mount assembly 1006, as described further herein. As discussed, the rotor 1008 includes channels that selectably couple ports 1012 formed by the stator 1010, where rotation of the rotor 1008 causes the channels to move between ports depending on operation of the valve actuator 1004. In embodiments, the valve body 1002 has a generally cylindrical shape (e.g., as shown in FIGS. 10-13), however the valve body 1002 is not limited to such shapes and can include, for example, a tapered shape, a rectangular shape, an irregular shape, or another shape. Additionally, the valve body 1002 may be larger (see FIGS. 12 and 13) or smaller to handle larger or smaller volumes, flow rates, etc., numbers of ports, and so forth. Moreover, the valve body 1002 is not limited to the configuration shown and may have other configurations. For example, the valve body 1002 may include ports 1012 having removably coupled fluid lines and can include fluid lines permanently coupled to one or more stator ports 1012.

Again, it should be noted that while the terms “stator” and “rotor” are used herein to describe the portions of the valve assembly 1000 defining fluid flow pathways, these terms are provided by way of example only (e.g., to illustrate how these components interface (e.g., rotate) with respect to one another), and are not meant to limit how the valve members can be actuated with respect to an external reference (e.g., valve mounting hardware, or the like). Thus, in one particular example, a component described as a “stator” may remain substantially stationary (e.g., with respect to an external reference, such as valve mounting hardware), and a component described as a “rotor” may rotate with respect to the stator. However, in another particular example, a component described as a “stator” may rotate with respect to a rotor, and a component described as a “rotor” may remain substantially stationary (e.g., with respect to valve mounting hardware). Further, in some implementations, both a component described as a “stator” and a component described as a “rotor” may rotate with respect to an external reference.

The mount assembly 1006 magnetically couples the valve body 1002 to the valve actuator 1004 so that the valve body 1002 is detachable from the valve actuator 1004 by a user. In this manner, for example, a user of the valve assembly 1000 can grasp the valve body 1002 and pull away from the valve actuator 1004, overcoming the force of the magnetic coupling, to remove the valve body 1002 from the valve actuator 1004 and subsequently reintroduce the same or different valve body 1002 to the valve actuator 1004 by placing the valve body 1002 in proximity to the actuator mount 1006 and allowing it to be magnetically coupled thereto.

In embodiments, the mount assembly 1006 includes a collar 1018 coupled to the valve actuator 1004 and a ring 1020 coupled to the valve body 1002. The collar 1018 and ring 1020 magnetically couple the valve body 1002 to the valve actuator 1004 so that the valve body 1002 can be removed from the valve actuator 1004, thereby allowing the valve body 1002 to be removed and replaced as desired (as discussed above). In embodiments, the collar 1018 and/or ring 1020 comprise at least one magnet 1022 configured to magnetically, detachably couple the ring 1020 to the collar 1018 to magnetically couple the valve body 1002 to the valve actuator 1004.

In the embodiment illustrated, the collar 1018 includes one or more magnets 1022. For example, as shown, the collar 1018 comprises a collar body 1024 having a valve actuator mating surface 1026 and a ring mating surface 1028. One or more magnet apertures 1030 are formed in the collar body 1024 through the valve actuator mating surface 1026. In embodiments, the magnet apertures 1030 are machined (e.g., drilled) into the collar body 1024 through the valve actuator mating surface 1026. However, the magnet apertures 1030 may be formed using other processes (e.g., casting, three-dimensional (3D) printing of the collar body 1024 to include the magnet apertures 1030, etc.). In the embodiment illustrated herein, the collar body 1024 includes three (3) magnet apertures 1030 holding three (3) magnets. However, it will be appreciated that the collar body 1024 have more or fewer than three (3) magnet apertures 1030 holding and equivalent number of magnets 1022. Additionally, in other embodiments, the magnet apertures 1030 may be formed in the collar body 1024 through the ring mating surface 1028. In embodiments, the magnets 1022 are secured within the magnet apertures 1030, for example, by an adhesive, a press fit, fasteners, combinations thereof, and so forth. The magnets 1022 may be made of a suitable magnetic material. In embodiments, the magnets 1022 comprise Neodymium magnets.

The ring 1020 includes a ring body 1032 having a valve body mating surface 1034 and a collar mating surface 1036. The ring 1020 comprises ferromagnetic material (e.g., iron, nickel, cobalt, steel, alnico, neodymium, samarium, etc.), which is magnetically attracted to the magnets 1022 in the collar 1018 when the collar mating surface 1036 of the ring 1020 is abutted against the ring mating surface 1028 of the collar 1018 to detachably secure the ring 1020 to the collar 1018. In one embodiment, the ring body 1032 is entirely formed of the ferromagnetic material. In another embodiment, the ring body 1032 includes embedded regions of ferromagnetic material that are positioned to be attracted to, and thus engage, the magnets 1022 of the collar 1018. For example, the ring body 1032 may be provided with one or more apertures to contain ferromagnetic material such as a post, a plug, a screw, etc. formed of the ferromagnetic material.

In another embodiment, the ring 1020 can include one or more magnets, while the collar 1018 comprises ferromagnetic material (e.g., iron, nickel, cobalt, steel, alnico, neodymium, samarium, etc.), which is magnetically attracted to the magnets in the ring 1020 to secure the ring 1020 to the collar 1018. For example, one or more magnet apertures may be formed in the ring body 1032 through the valve body mating surface 1034 or the collar mating surface 1036. In embodiments, the magnet apertures are machined (drilled) into the ring body 1032, however, the magnet apertures may be formed using other processes (e.g., casting, three-dimensional (3D) printing of the ring body 1032 to include the magnet apertures, etc.). In this embodiment, the collar 1018 comprises ferromagnetic material (e.g., iron, nickel, cobalt, steel, alnico, neodymium, samarium, etc.), which is magnetically attracted to the magnets in the ring 1020 when the collar mating surface 1036 of the ring 1020 is abutted against the ring mating surface 1028 of the collar 1018 to detachably secure the ring 1020 to the collar 1018. Moreover, the collar body 1024 may be entirely formed of the ferromagnetic material or may include embedded regions of ferromagnetic material that are positioned to be attracted to, and thus engage, the magnets of the ring 1020. For example, the collar body 1024 may be provided with one or more apertures to contain ferromagnetic material such as a post, a plug, a screw, etc., formed of the ferromagnetic material.

In a further embodiment, both the collar 1018 and ring 1020 may include one or more magnets, whose poles are aligned (e.g., North (N) to South (S)) to attract one another to secure the ring 1020 to the collar 1018. For example, one or more magnet apertures may be formed in the collar body 1024 through the valve actuator mating surface 1026 or the ring mating surface 1028. Similarly, one or more magnet apertures may be formed in the ring body 1032 through the valve body mating surface 1034 or the collar mating surface 1036. Magnets are inserted into the magnet apertures 1030 so that the magnetic poles of the magnets 1022 in the collar 1018 and ring 1020 are aligned to attract one another. For example, magnets 1022 inserted into the magnet apertures of the collar body 1024 may have their North (N) pole facing the ring mating surface 1028 toward the ring 1020, while magnets inserted into the magnet apertures of the ring body 1032 may have their South (S) pole facing the collar mating surface 1036 toward the collar 1018, or alternately, magnets inserted into the magnet apertures of the collar body 1024 may have their South (S) pole facing the ring mating surface 1028 toward the ring 1020, while magnets inserted into the magnet apertures of the ring body 1032 may have their North (N) pole facing the collar mating surface 1036 toward the collar 1018 so that the magnets 1022 attract one another to secure the ring 1020 to the collar 1018. In embodiments, the magnet apertures are machined (drilled) into the collar body 1024 and ring body 1032, however, the magnet apertures may be formed using other processes (e.g., casting, three-dimensional (3D) printing of the collar body 1024 and ring body 1032 to include the magnet apertures 1030, etc.).

Moreover, in this embodiment, the magnets 1022 may be arranged to provide keyed magnetic coupling. For example, magnets 1022 having alternating polarities may be arranged around the collar 1018 and the ring 1020 so that the valve body 1002 couples to the valve actuator 1004 in a predetermined rotational orientation. Thus, one or more of the magnets of the collar 1018 may be arranged so that their North (N) pole is facing the ring mating surface 1028 toward the ring 1020, while one or more magnets are arranged so that their South (S) pole is facing the ring mating surface 1028 toward the ring 1020. Similarly, one or more of the magnets of the ring 1020 may be arranged so that their South (S) pole is facing the collar mating surface 1036 toward the collar 1018 to engage (magnetically couple to) the magnets in the collar having their North (N) pole facing the ring mating surface 1028 toward the ring 1020, while one or more of the magnets of the ring 1020 may be arranged so that their North (N) pole is facing the collar mating surface 1036 toward the collar 1018 to engage (magnetically couple to) the magnets in the collar having their South (S) pole facing the ring mating surface 1028 toward the ring 1020.

In a further embodiment, one or both of the collar body 1024 and ring body 1032 may be entirely formed of a magnetic material. In embodiments where both the collar body 1024 and ring body 1032 are entirely formed of magnetic material, the ring mating surface 1028 and collar mating surface 1036 may have opposite poles (e.g., North (N) or South (S)) so that the collar 1018 is magnetically attracted to the ring 1020.

As shown, the collar 1018 includes a collar aperture 1038 extending axially through the collar body 1024. Similarly, the ring 1020 includes a ring aperture 1040 extending axially through the ring body. The collar and ring apertures 1038 and 1040 are aligned so that, when the ring 1020 is magnetically mounted to the collar 1018, they form a single aperture extending through the mount assembly 1006 to receive a drive shaft 1042 when the valve body 1002 is coupled to the valve actuator 1004 by the mount assembly 1006. The drive shaft 1042 is coupled with a motor or drive 1016 of the valve actuator 1004 and rotatably engages the valve body 1002 (e.g., via one or more internal bearings) to operate the valve body 1002.

The collar 1018 is fixedly coupled to a mounting face 1044 of the valve actuator 1004. For example, in the embodiment illustrated, the collar body 1024 of the collar 1018 includes a plurality of collar attachment holes 1046 to receive fasteners (not shown) for securing the collar body 1024 to mounting face 1044 of the valve actuator 1004. Similarly, the ring 1020 is fixedly coupled to the valve body 1002. For example, in the embodiment illustrated, the ring body 1032 of the ring 1020 includes a plurality of ring attachment holes 1048 to receive fasteners (not shown) for securing the ring body 1032 to a mounting face of the valve body 1002. However, it is contemplated that other fastening devices or methods (e.g., adhesive, magnetic, etc.) may be used to couple the collar 1018 and ring 1020 to the valve actuator 1004 and valve body 1002, respectively.

As shown, the collar mating surface 1036 is configured to engage the ring mating surface 1028 when the mount assembly 1006 magnetically couples the valve body 1002 to the valve actuator 1004. For example, in the embodiment illustrated, the ring mating surface 1028 is disposed at an end 1050 of the collar body 1024, while the collar mating surface 1036 is disposed at an end of the ring body 1032 so that the ring mating surface 1028 abuts the collar mating surface 1036 when engaged with the collar mating surface 1036. In this embodiment, the collar 1018 includes an annular recessed area 1052 extending from the ring mating surface 1028 into the collar aperture 1038. Correspondingly, the ring 1020 includes an annular lip 1054 extending from the collar mating surface 1036 about the ring aperture 1040. The annular lip 1054 extends into the annular recessed area 1052 when ring mating surface 1028 abuts the collar mating surface 1036 to align and center the collar 1018 and ring 1020 so that the collar and ring apertures 1038 and 1040 are aligned. In the embodiment illustrated, the annular lip 1054 is formed on the ring body 1032 while the annular recessed area 1052 is formed within the collar aperture 1038 of the collar body 1024. However, it is contemplated that the annular lip may be formed on the collar body 1024 while the annular recessed area is formed within the ring aperture 1040 of the ring body 1032, or that other mating structures may be provided.

In embodiments, the collar 1018 and ring 1020 include one or more mating features 1056 to prevent rotation of the valve body 1002 relative to the valve actuator 1004. For example, as shown, the ring mating surface 1028 of the collar body 1024 includes at least one aperture 1058 (two (2) apertures 1058 are shown) and the collar mating surface 1036 of the ring body 1032 includes at least one protrusion 1060 (two (2) protrusions 1060 are shown). The protrusions 1060 are configured to engage the aperture 1058 when the ring mating surface 1028 is engaged with the collar mating surface 1036 to prevent rotation of the valve body 1002 relative to the valve actuator 1004. In the embodiment illustrated, the apertures 1058 are machined (e.g., drilled) into the collar body 1024 through the ring mating surface 1028. However, the apertures 1058 may be formed using other processes (e.g., casting, three-dimensional (3D) printing of the collar body 1024 to include the magnet apertures 1030, etc.). Similarly, as shown, the protrusions 1060 may comprise posts 1062 inserted into apertures 1064 formed in the ring body 1032 and positioned so that the posts 1062 engage (e.g., be inserted into) the apertures 1058 formed in the collar body 1024 when the ring mating surface 1028 is engaged with the collar mating surface 1036. In embodiments, the posts 1062 are secured within the apertures 1064, for example, by a press fit, an adhesive, fasteners, combinations thereof, and so forth.

While the mount assembly 1006 is shown having mating features 1056 that comprise two (2) apertures 1058 and two (2) corresponding protrusions 1060, the mount assembly 1006 is not limited to a particular number or arrangement of mating features 1056. For example, the mount assembly 1006 can include a single aperture 1058 and a single corresponding protrusion 1060 or the mount assembly 1006 can include greater than two (2) apertures 1058 and corresponding protrusions 1060. Additionally, the mount assembly 1006 is not limited to the use of cylindrical posts 1062 and correspondingly shaped apertures 1058 and 1064 and can include any shape of aperture 1058 and 1064 and corresponding shape of protrusion 1062.

In embodiments, the positioning of the aperture(s) 1058 and the protrusion(s) 1060 can provide a keyed arrangement of the valve body 1002 relative to the valve actuator 1004, such that the valve body 1002 is oriented in a particular direction relative to the valve actuator 1004, ensuring proper orientation of the valve assembly 1000 for fluid flow configurations and changing valve orientations via rotation of the rotor 1008 by the valve actuator 1004. Alternatively or additionally, the magnets 1022 of the mount assembly 1006 (collar 1018 and/or ring 1020) can provide a keyed arrangement of the valve body 1002 relative to the valve actuator 1004, such as by providing selective areas of the mount assembly 1006 (collar 1018 and/or ring 1020) with magnetically attractive material, and with the remaining areas of the mount assembly 1006 (collar 1018 and/or ring 1020) being not magnetically attractive, by providing magnets 1022 with opposing poles on each of the collar 1018 and/or ring 1020 to magnetically couple in a particular orientation, or the like.

The number and/or positioning of the apertures 1058 and corresponding protrusions 1060 can be selected to provide multiple coupling arrangements and to accommodate varied sizes or types of valve bodies 1002 and mount assemblies 1006 (e.g., such as when the mount assemblies 1006 can interface with multiple different types or sizes of valve body 1002). For example, the apertures 1058 and corresponding protrusions 1060 can be positioned radially outward from the edges of the collar and ring apertures 1038 and 1040, respectively, at different radii, or radially inward from exterior edges 1066 and 1068 of the collar and ring bodies 1024 and 1032, respectively, at different radii, to accommodate, identify, and/or permit attachment of specific valve bodies 1002 to the valve actuator 1004.

Further, while the collar 1018 is described having one or more apertures 1058 formed in the collar body 1024 and the ring 1020 is described as having one or more corresponding protrusions 1060, it is noted that the apertures 1058 can be positioned on either or both of the collar 1018 and the ring 1020, with the corresponding protrusions 1060 positioned on the other of the ring 1020 and the collar 1018. For example, in some implementations, one or more apertures 1058 can be formed in the ring body 1032 of the ring 1020 with one or more corresponding protrusions 1060 extending from the collar body 1024 of the collar 1018.

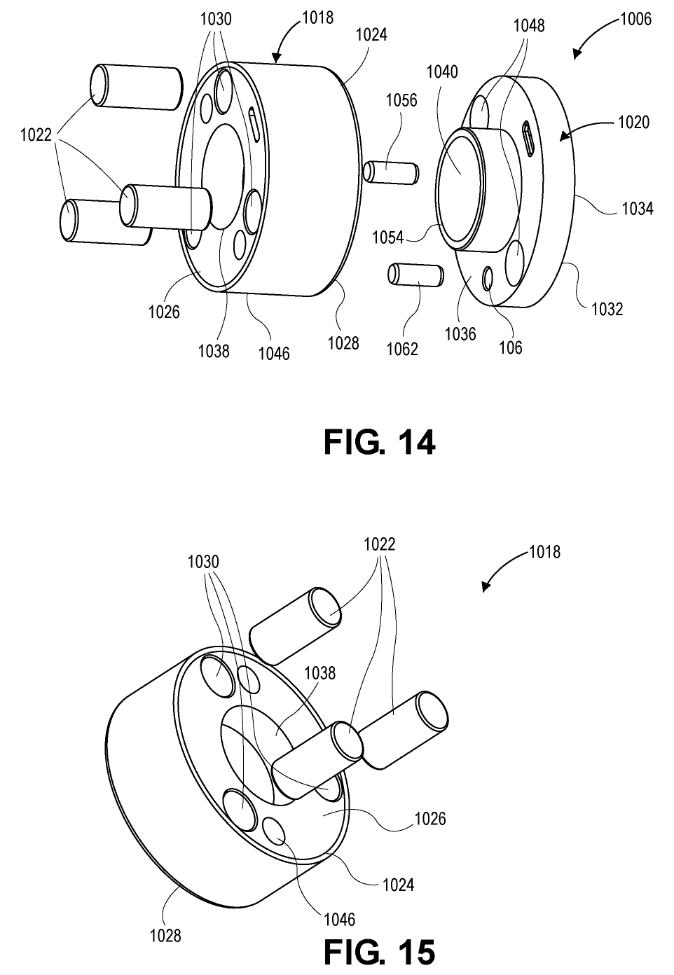

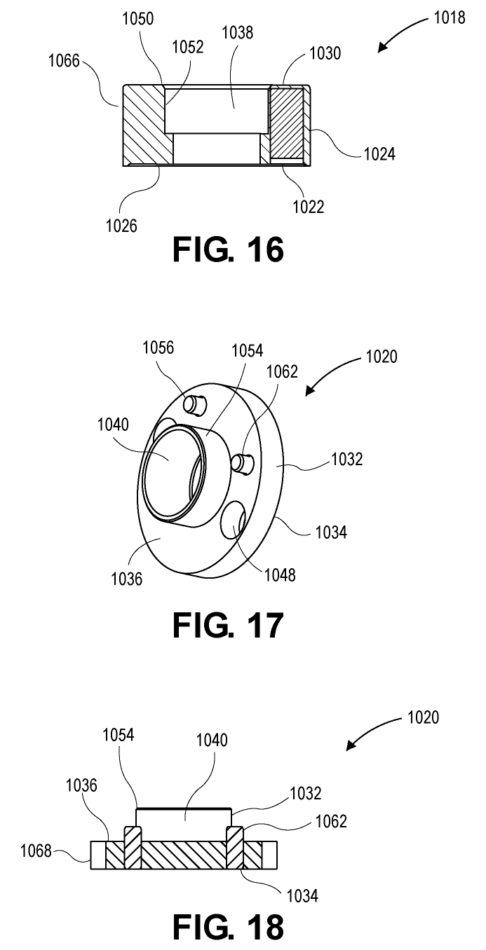

In FIGS. 10-17, the mount assembly 1006 is shown as including a collar 1018 mounted to the valve actuator 1004 and a ring 1020 mounted to the valve body 1002, wherein the collar 1018 is shown as having a collar body 1024 that is greater in thickness or length than the ring body 1032 of the ring 1020. Moreover, the collar body 1024 and ring body 1032 are shown as having the same diameter. However, the collar body 1024 and the ring body 1032 need not necessarily be limited to the thicknesses or diameters illustrated. Thus, in embodiments, the ring body 1032 may have a thickness greater than or equal to the thickness of the collar body 1024. Additionally, the collar body 1024 and the ring body 1032 may have different thicknesses.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A valve assembly comprising:
a valve body, the valve body including a rotor and a stator configured to define a plurality of fluid flow passageways;
a valve actuator configured to drive the rotor via a drive shaft; and
a mount assembly configured to detachably magnetically couple the valve body and the valve actuator.

2. The valve assembly of claim 1, wherein the mount assembly comprises:
a collar configured to be coupled to the valve actuator; and
a ring configured to be coupled to the valve body;
wherein at least one of the collar or the ring comprises at least one magnet, and the other of the collar or the ring comprises a ferromagnetic material or at least one magnet configured to magnetically attract the at least one magnet to detachably couple the ring to the collar.

3. The valve assembly of claim 1, wherein the collar comprises a ring mating surface and the ring comprises a collar mating surface, the collar mating surface configured to engage the ring mating surface when the mount assembly magnetically couples the valve body to the valve actuator.

4. The valve assembly of claim 3, wherein the ring mating surface is disposed at an end of the collar, and the collar mating surface is disposed at an end of the ring so that the ring mating surface abuts the collar mating surface when engaged with the collar mating surface.

5. The valve assembly of claim 4, wherein the ring mating surface includes at least one aperture and the collar mating surface includes at least one protrusion, the at least one protrusion configured to engage the at least one aperture when the ring mating surface is engaged with the collar mating surface to prevent rotation of the valve body relative to the valve actuator.

6. The valve assembly of claim 4, wherein the collar includes a collar aperture extending axially through the collar and the ring includes a ring aperture extending axially through the ring, and wherein the drive shaft is configured to pass through the collar and ring apertures when the valve body is coupled to the valve actuator by the mount assembly.

7. The valve assembly of claim 6, wherein collar includes an annular recessed area extending from the ring mating surface into the collar aperture and the ring comprises an annular lip extending from the collar mating surface about the ring aperture, the annular lip extending into the annular recessed area when ring mating surface abuts the collar mating surface.

8. The valve assembly of claim 2, wherein the collar includes at least one collar attachment hole extending through the collar for receiving a fastener to attach the collar to the valve actuator, and the ring includes at least one ring attachment hole extending through the ring for receiving a fastener to attach the ring to the valve body.

9. The valve assembly of claim 2, wherein the at least one magnet is disposed within magnet apertures formed in one or both of the collar and the ring.

10. A mount assembly for mounting a valve body including a rotor and a stator configured to define a plurality of fluid flow passageways to a valve actuator configured to drive the rotor via a drive shaft, the mount assembly comprising:
a collar configured to be coupled to the valve actuator; and
a ring configured to be coupled to the valve body;
wherein at least one of the collar or the ring comprises at least one magnet, and the other of the collar or the ring comprises a ferromagnetic material or at least one magnet configured to magnetically attract the at least one magnet to detachably couple the ring to the collar.

11. The mount assembly of claim 10, wherein the collar comprises a ring mating surface and the ring comprises a collar mating surface, the collar mating surface configured to engage the ring mating surface when the mount assembly magnetically couples the valve body to the valve actuator.

12. The mount assembly of claim 10, wherein the ring mating surface is disposed at an end of the collar, and the collar mating surface is disposed at an end of the ring so that the ring mating surface abuts the collar mating surface when engaged with the collar mating surface.

13. The mount assembly of claim 12, wherein the ring mating surface includes at least one aperture and the collar mating surface includes at least one protrusion, the at least one protrusion configured to engage the at least one aperture when the ring mating surface is engaged with the collar mating surface to prevent rotation of the valve body relative to the valve actuator.

14. The mount assembly of claim 12, wherein the collar includes a collar aperture extending axially through the collar and the ring includes a ring aperture extending axially through the ring, and wherein the drive shaft is configured to pass through the first and ring aperture when the valve body is coupled to the valve actuator by the mount assembly.

15. The mount assembly of claim 14, wherein collar includes an annular recessed area extending from the ring mating surface into the collar aperture and the ring comprises an annular lip extending from the collar mating surface about the ring aperture, the annular lip extending into the annular recessed area when ring mating surface abuts the collar mating surface.

16. The mount assembly of claim 10, wherein the collar includes at least one collar attachment hole extending through the collar for receiving a fastener to attach the collar to the valve actuator, and the ring includes at least one ring attachment hole extending through the ring for receiving a fastener to attach the ring to the valve body.

17. The mount assembly of claim 10, wherein the at least one magnet is disposed within magnet apertures formed in one or both of the collar and the ring.

18. A mount assembly for mounting a valve body including a rotor and a stator configured to define a plurality of fluid flow passageways to a valve actuator configured to drive the rotor via a drive shaft, the mount assembly comprising:
a collar configured to be coupled to the valve actuator; and
a ring configured to be coupled to the valve body, wherein at least one of the collar or the ring comprises at least one magnet, and the other of the collar or the ring comprises a ferromagnetic material or at least one magnet configured to magnetically attract the at least one magnet to magnetically detachably couple the ring to the collar; and
one or more corresponding mating features to prevent rotation of the valve body relative to the valve actuator when the valve body is magnetically coupled to the valve actuator by the mount assembly

19. The mount assembly of claim 18, wherein the collar comprises a ring mating surface disposed at an end of the collar and the ring comprises a collar mating surface disposed at an end of the ring, the collar mating surface configured to abut the ring mating surface when the mount assembly magnetically couples the valve body to the valve actuator.

20. The mount assembly of claim 12, wherein the collar includes a collar aperture extending axially through the collar, the collar aperture including an annular recessed area extending from the ring mating surface into the collar aperture, and the ring includes a ring aperture extending axially through the ring and an annular lip extending from the collar mating surface about the ring aperture, the annular lip extending into the annular recessed area when ring mating surface abuts the collar mating surface, and wherein the drive shaft is configured to pass through the first and ring apertures when the valve body is coupled to the valve body by the mount assembly.
